(19) United States
(12) Patent Application Publication
(10) Pub. No.: US 2010/0094676 A1
(43) Pub. Date: Apr. 15, 2010

(54) CLOSED LOOP SELF CORRECTIVE MAINTENANCE WITHIN A DOCUMENT PROCESSING ENVIRONMENT

(75) Inventors: Robert R. Perra, Cary, NC (US); James M. Guberski, Holly Springs, NC (US); Donald F. Bullock, Raleigh, NC (US)

Correspondence Address: MCDERMOTT WILL & EMERY LLP, 600 13TH STREET, N.W., WASHINGTON, DC, 20005-3096, US

(73) Assignee: BOWE BELL + HOWELL COMPANY

(21) Appl. No.: 12/249,304

(22) Filed: Oct. 10, 2008

(51) Int. Cl. G06Q 10/00

(52) U.S. Cl. 705/8

(57) ABSTRACT

The present application relates to techniques for closed loop monitoring and performance control of document processing equipment within a document processing facility. In particular, a maintenance feedback system and related methods for coordinating service actions for document processing equipment are disclosed, for determining the impact that an identified fault correction or performance service has on the actual operational performance of the document processing equipment.

### TECHNICAL FIELD

The subject matter presented relates to a method, apparatus and program product for coordinating service actions within a document processing environment.

### BACKGROUND

In a machine processing facility, where multiple high-end electro-mechanical devices operate for the execution and fulfillment of specific tasks, maintenance of such machines is critical to the given business. Take for example a mail or document processing facility for a mail processing business, which may employ one or more sorters, inserters, cutters, vision based verification systems, meters and one or more control processors for coordinating the generation and production of mail items. Environments like this require precision machine processing, speed and accuracy in order to meet the mission critical mail production requirements of different mailers in accord with postal authority standards. Regardless of the operating environment or context, the various machine resources employed for the fulfillment of a business task are valuable assets that must be maintained to ensure viability.

Reliability Centered Maintenance (RCM) is a maintenance paradigm and methodology employed by service professionals for the purpose of sustaining physical (machine) assets. RCM involves the identification of the expected functions of the equipment to be used within the organization, identification of the components comprising the equipment or systems, determination of the potential faults that may occur with respect to each component and the identification of causes that allow the faults to occur. With this approach in mind, maintenance procedures or “logic” may be defined for addressing such faults when they occur, or for attempting to design such faults out of the system.

Regardless of the maintenance paradigm or methodology employed, there is currently no means to readily determine the impact an identified fault correction or performed service action has on the actual operational performance of the machine. For example, if as a result of a recently performed service action a problematic sort processing device exhibits no change in its lackluster mail processing throughput—an operational performance indicator—there is currently no means of providing expedient feedback to the service technician that the performed service procedure has had no impact. At best, the service technician must wait for a period of time before such feedback is rendered—i.e., after a period of time of the machine being online, which often comes well after the maintenance was performed and/or the service technician has left. Consequently, if the machine operational performance has not changed due to the service procedure performed, valuable time and resources must be expended again for the purpose of coordinating the service tech, the machine, parts and the other resources needed to correct the performance issue.

Furthermore, where maintenance service actions are performed in accord with best practice instructions per a given maintenance paradigm, there is currently no convenient means to automate the feedback necessary for constant refinement of best practice instructions. This is most unfortunate in instances where a few key variables (e.g., service technician experience, part usage, service nuances) as applied with respect to a recommended service action results in increased operational performance of the machine in question. Opportunities to adapt the prescribed maintenance approach—based on direct operational performance feedback regarding that machine after it is serviced using the approach—may be lost.

Accordingly, there exists a need in the art for a machine maintenance feedback system and related method for coordinating service actions within a document processing environment, for determining the impact an identified fault correction or performance service has on the actual operational performance of the machine.

### SUMMARY

It is desirable to provide a method for closed loop monitoring and control of performance of document processing equipment within a document processing facility. The method includes gathering performance metrics that characterize the operational performance of document processing equipment within the document processing facility. A performance degradation of the document processing equipment is detected based on the performance metrics. Upon detection of the performance degradation, a corrective response action is triggered. The corrective response includes: identifying event data for isolating one or more specific functional or physical causes of the degradation associated with the document processing equipment; and coordinating resources necessary for executing identified best practice service instructions. Upon execution of the best practice service instructions, validating that operational performance of the document processing equipment is corrected.

It is further desirable to provide a method for coordinating resources in response to performance degradation of document processing equipment within a document processing facility. The method includes identifying one or more best practice service instructions from a set to be performed to address the performance degradation, the performance degradation including one or more specific functional or physical causes of the degradation associated with the document processing equipment. Resources for executing the best practice service instructions are coordinated, wherein the resources are selected from one or more of the following: a part, production scheduling, skill set, personnel or equipment. Following execution of the best practice service instruction(s), it may also be desirable to validate that operational performance of the document processing equipment is corrected. Upon validation, the set of best practice service instructions is updated.

Still further, it is desirable to provide for a method for arranging a service request in response to performance degradation of document processing equipment within a document processing facility. The method includes receiving notification of implementation of best practice service instruction(s) on the document processing equipment, wherein the best practice instructions are implemented in response to detected degradation in the document processing equipment. The document processing equipment is activated subsequent to the implementation of the best practice service instruction(s). A service request is requested to standby pending a determination of operational performance of the document processing equipment subsequent to the implementation of the best practice service instructions. The operational performance of the document processing equipment is evaluated subsequent to the activation of the document processing equipment. The service technician is alerted to implement an additional best practice service instruction when the degradation still persists, based upon results of the evaluation.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 depicts an exemplary high-level block diagram of a machine maintenance feedback system for responding to instances of machine performance degradation within a document processing environment.

FIGS. 2, 3 and 4 are exemplary flowcharts depicting the logical steps employed by the machine maintenance feedback system for responding to degradation in machine performance.

FIG. 5 illustrates a network or host computer platform, as may typically be used to implement a server.

FIG. 6 depicts a computer with user interface elements.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

As used herein, a maintenance service provider is any organization responsible for maintaining, servicing, fixing or addressing any functional, physical or operational limitations that may occur within a given machine on behalf of a customer that operates a document processing environment. Typical maintenance service providers will operate in accord with a service contract, maintenance agreement or warranty specification on behalf of the customer, and will employ multiple field service personnel (e.g., technicians, application engineers, field service engineers). In the context of the teachings presented herein, the maintenance service provider may perform a service request in response to a determination of a machine operational performance, e.g. based on data that characterizes the general operational performance of a machine with respect to its intended function.

As another example, a mail inserting machine may yield operational performance metrics such as: average machine throughput, average jam occurrences per job run or per hour, average number of reprints per job or per hour, etc. Those skilled in the art will recognize that such metrics usable as operational performance data may vary. Of particular interest is that such metrics do not in and of themselves indicate the particular modules or components within the machine the lead to such performance.

The teachings presented herein pertain to a system and method for implementing and enabling a machine maintenance feedback system, wherein operational performance data respective to a machine that was recently serviced in accord with a maintenance approach may be more readily communicated, understood and addressed. In this way, when machine operational performance is determined to be satisfactory subsequent to an associated best practice service action or instruction performed, the determination may act as impetus (feedback) to trigger the adaptation of best practice service actions or instructions. When machine operational performance data is determined to be unsatisfactory subsequent to an associated best practice service action or instruction performed, the determination may act as impetus (feedback) to communicate additional best practice service actions to be performed expeditiously.

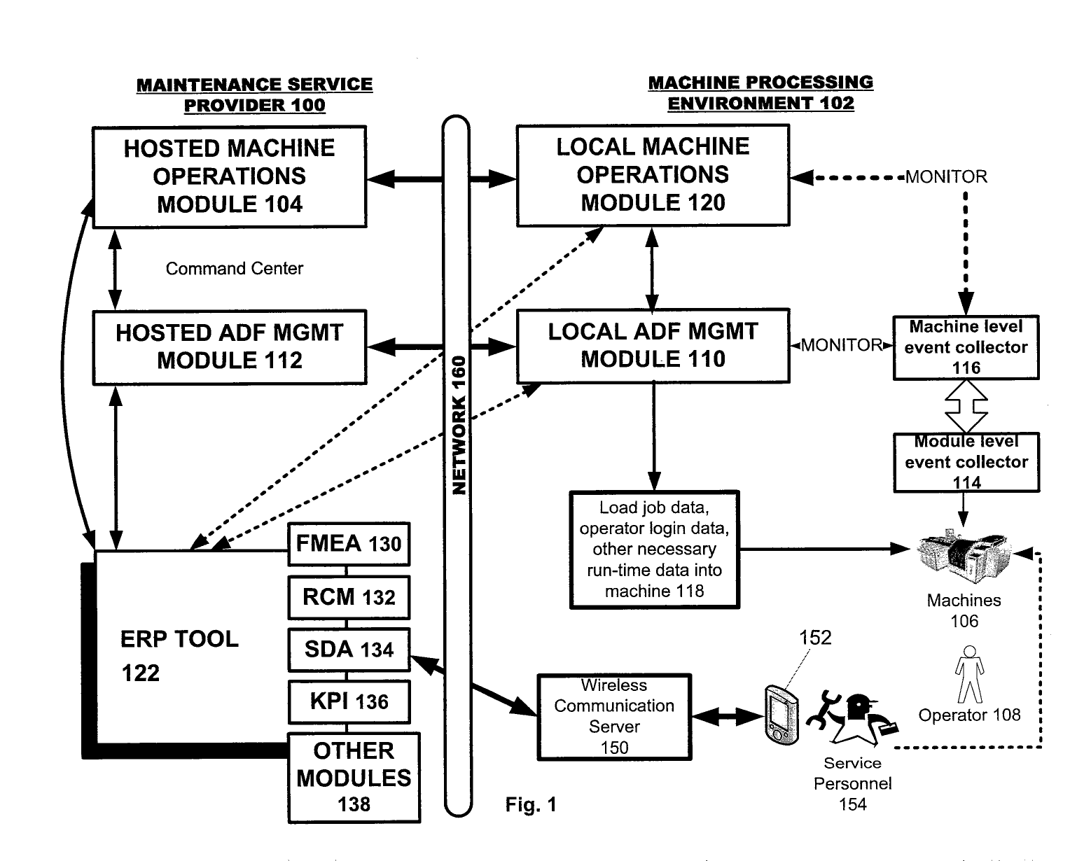

FIG. 1 depicts an exemplary high-level block diagram of a machine maintenance feedback system for responding to instances of machine performance degradation within a document processing environment. An exemplary document processing environment 102 may include any facility wherein one or more resources in the form of machines 106, devices, data, and personnel/operator(s) 108 are utilized for the production of documents within the document processing context. For the purpose of the discussion, the document processing environment presented herein will be from the perspective of a mail processing facility—i.e., an automated document factory, captive shop, letter shop, pre-sort bureau or other facility engaged in the manufacture or distribution of mail in accord with a postal authority or other mail carrier network. Typical mail processing facilities may include, but are not limited to, sorters for sorting mail items according to a sort scheme, inserters, cutters, printers and folders for preparing mail items for display and distribution, mail bins for accumulating the multitude of mail items processed, etc.

Specifically, the one or more machines 106, personnel/operator(s) 108 and other resources operating within the document processing environment 102 are managed and controlled by an automated document factory (ADF) management module 110. The ADF management module 110 is a firmware and/or software based tool for managing various operational aspects of the document processing environment. From the context of a mail processing environment, this may include but is not limited to the mail item production process, mail item tracking, machine processing, job processing, data services, document generation, customer management, inventory control, operator resourcing and other vital functions of the mail processing facility. Given the wide array of functional and operational aspects of the document processing environment, the ADF management module 110 may receive data of differing types for facilitating high-level machine and production management visibility

For example, in a mail processing environment 102, the ADF management module 110 may be used to perform initial coordination and arranging of jobs requiring the processing of mail items via the various machines 106 available for use. This may include, prior to execution of a job run, loading job data, scheduling and logging in a particular operator 108 to run the job, loading machine instructions (e.g., an inserter data file), loading other run-time data, etc 118. Upon runtime, machine level event data may be persistently maintained and monitored by a machine level event data collector 116, an executable module or operating system operable in connection with a particular machine 106. Alternatively, a single machine level event collector 116 may interact with multiple machines, where it distinctively monitors and distinguishes between the data sets provided by each machine. The machine level event collector 116 may perform various functions, including but not limited to, monitoring machine and/or job data, identifying data types as generated by the various components of the machine during run-time machine processing, and presenting the data to a graphical user interface of the machine or relaying the data to another interested node. The machine level event data collector 116 may operate as a stand alone module on a machine by machine basis or in conjunction with the ADF management module 110 for facilitating high-level machine and production management visibility.

In particular, the machine-level event data collector 116 may operate in association with the ADF management module 110 for supplying event data descriptive of the general state or status of the machine 106 itself—i.e., state, mode or status of an inserter, sorter, vision system, etc. Exemplary state or status messages discernable via data provided by the machine level event data collector may be those indicative of a current job run in execution (e.g., JOB 1 started at 12:32:01), machine activity status (e.g., MACHINE 5 inactive), or other data useful for characterizing the operational state of that machine. Operating in connection with collector 116 is a module-level event data collector 114 that further monitors and conveys event data descriptive of the state or status of specific physical components that comprise a given machine 106—i.e., state, mode or status of particular sensors, solenoids, drive motors, etc of the machine 106. Exemplary state or status messages discernable via data provided by the module level event collector 114 may be those indicative of the operation and function of components (e.g., MOTOR A=ON at 1:32:05; OFF at 1:33:03). The module level event data collector 114 may receive input from a plurality of photoelectric cells and timers physically placed throughout the machine that detect state changes or altering electro-mechanical actions of the various machine components.

Hence, the ADF management module 110 may receive data pertaining to the various machines in operation from a plurality of data sources. Also, while not shown expressly, the ADF management module 110 may receive data from sources required to enable full management of the overall document processing environment 102, including a customer relationship management (CRM) database, postal authority item tracking database, address list processor, human resources database and other input sources. Typically, the ADF management module 110 may operate locally—i.e., run as a distributed or concentrated module on one or more computing devices or servers within the document processing environment 102, and/or may operate as a hosted solution 112, wherein its various management modules are presented as one or more browser-based executables or web services via a network 160. An exemplary ADF management module 110 is presented by way of example with respect to U.S. patent application Ser. No. 11/802,301, filed May 22, 2007, entitled Intelligent Document Composition for Mail Processing, and which is incorporated by reference herein in its entirety. Skilled practitioners will recognize that various kinds of document processing environment control and management tools are available, and that teachings presented herein are not limited to any one implementation.

In addition to feeding data to the ADF management module 110, the machine level event data collector 116 may also communicate with a machine operations module 120. In particular, the machine operations module 120 is a service and maintenance tool that monitors the data provided by the machine level event data collector 116 and analyzes it to determine the operational and functional status or performance of the machines for service purposes. For instance, the machine operations module 120 may analyze the event level machine data to determine the current throughput characteristics of a specific machine or to perform diagnostic analysis checks respective to the machine. Such analysis may be useful to the service maintenance provider 100—i.e., contracted by the document processing environment 102 in accordance with a service agreement—for indicating the occurrence of performance degradation respective to the machine, further indicating the occurrence of faults or failures that require service action.

The machine operations module 120 may operate locally as a distributed or concentrated module on one or more computing devices or servers within the document processing environment 102 and/or may operate as a hosted solution 104. In the case of a hosted solution, the machine operations module 104 need not execute on any devices within the document processing environment 102 but rather, may interface with the machine level event collector 116 via a network 160. In other instances, where performance needs and document processing environment 102/facility specifications require, the local 120 and hosted 104 solutions may be employed; the local machine operations module 120 acting as a communication conduit between a service monitoring, dispatch and command center of the service provider 100 and the document processing environment 102 (customer) operating the machine level event data collector 116. In addition, the local machine operations module 120 and hosted machine operations module 104 may feature various visual displays and interfaces for enabling direct service based visibility of the machines 106 within the document processing environment 102. Again, those skilled in the art will recognize that various system configurations and interactive arrangements may be employed without limiting the scope of the teachings presented.

In the exemplary machine maintenance feedback system depicted herein, the hosted implementations of the machine operations module 104 and the ADF management module 112 are capable of exchanging data. While not a requirement, such an arrangement may enable advanced control and monitoring functions on the part of the service provider 100 for responding to service or maintenance needs with respect to the customer's 102 machine assets 106. For example, the service provider 100 may monitor the machine assets while also taking into account environmental factors that affect the customer's document processing environment 102—i.e., inventory, operators 108, job requirements, operating hours, etc. In order to respond to service or maintenance issues due to degradations in machine performance—as determined through persistent monitoring of the machine by the machine operations module 120/104 and/or information presented by the ADF management module 112/110—the service provider 100 must ensure proper coordination of its own people, time, machines, parts, tools and other resources to address the problem. Moreover, the service provider 100 must have a suitable system and functional procedure for applying best practice service techniques to address any detected operational performance degradation respective to a given machine asset.

To address this requirement, the exemplary machine maintenance feedback system presented herein further integrates the machine operations module 104 and ADF management module 112 with an enterprise resource planning (ERP) tool 122 (e.g., SAP ERP, xTuple ERP, Microsoft Dynamics). The ERP tool further employs various maintenance related executable modules suitable for enabling differing functional capabilities useful for responding to instances of machine performance degradation within the document processing environment 102. The various service and maintenance executable modules are described in TABLE 1 below:

TABLE 1
Various executable modules employable by the enterprise resource planning tool

| Module Name | Function/Comment |
|---|---|
| Failure Modes and | A module for analyzing the potential failure modes that may occur |
| Effects Analysis | within a system for classification by severity or determination of the |
| (FMEA) module | failures' effect upon the system. Failure modes are any potential or |
| 130 | actual errors, defects or faults respective to machine processing or |
| | design that may impact performance. Effects analysis refers to studying |
| | the consequences of those failures. The module performs its analysis in |
| | accord with various factors, including but not limited to, data |
| | representing: the manner by which the failure or fault is observed |
| | (failure mode), consequences of the failure or fault (failure effect), |
| | severity of the failure or fault to the system, potential causes of the |
| | failure or fault, number of occurrences of the failure or fault, risk level |
| | of the associated failure or fault, etc. The FMEA module 130 may |
| | include various instructions called upon in accord with predefined |
| | failure modes established by the maintenance service provider 100 in |
| | relation to a particular machine type or machine processing context. |
| Reliability Centered | A module for identifying and establishing the best practice service |
| Maintenance | instructions-operational, maintenance, and asset preservation and |
| (RCM) Module 132 | improvement policies-for managing the determined risks resulting |
| | from the occurrence of a particular machine failure or fault most |
| | effectively. The RCM Module 132 responds accordingly to the |
| | identified failure modes and effects analysis performed by the FMEA |
| | Module 130, and may call for the execution or integration of varying |
| | models or techniques for maintenance performance (e.g., predictive |
| | maintenance, conditional monitoring, run-to-failure, preventative |
| | maintenance). The RCM module 132 may include various instructions |
| | called upon in accord with a specific maintenance framework or |
| | approach as established by the maintenance service provider 100. |
| Service Data | A module for enabling field service personnel 154 employed by the |
| Automation (SDA) | service maintenance provider 100 to communicate and interact with the |
| Module 134 | ERP tool 122 and its various other executable modules as required for |
| | responding to and engaging maintenance service. The SDA module |
| | 134 enables the field service personnel 154 to create and complete |
| | service reports via a network ready handheld device 152, such as a |
| | Smartphone or BlackBerry device. SDA defines the various protocols |
| | necessary to enable exchange of data between the field service |
| | personnel's handheld directly running a local SDA application via a |
| | wireless communication server 150 and the ERP tool 122. It enables |
| | users to account for service time spent, log materials, record service |
| | activities, order parts, etc. The SDA module 134 may include various |
| | instructions as established by the maintenance service provider 100 in |
| | conjunction with a wireless communication server 150/provider. |
| Key Performance | A module for computing key performance indicators (KPIs) as defined |
| Indicator (KPI) | by the service maintenance provider 100 based on the identified failure |
| Module 136 | modes. The KPI Module 136 generates metrics that are indicative of |
| | and in alignment with the service maintenance provider's strategic |
| | goals and critical success factors. Exemplary indicators pertaining to |
| | the service organization may include, but are not limited to, metrics |
| | indicating average service time spent on a full service personnel or per |
| | personnel basis, average service call response time on a full service |
| | personnel or per personnel basis, amount of training received in |
| | specific areas on a on a full service personnel or per personnel basis, |
| | average part delivery time on a per vendor basis, average revenue |
| | generated per service call, supply chain scorecard indicators, etc. The |
| | metrics computed by the KPI Module 136 may include both leading |
| | and lagging indicators. Categories of indicators (metrics) suitable for |
| | representating a KPI may include the following: |
| | Quantitative indicators which can be presented as a number. |
| | Practical indicators that interface with existing company |
| | processes. |
| | Directional indicators specifying whether an organization is |
| | getting better or not (e.g., commonly used to generate dashboards or |
| | other visual indicators). |
| | Actionable indicators representing an organization's control to |
| | effect change. |
| | The KPI module 136 may include various instructions-and |
| | particularly those for deciding the service approach or action to be |
| | taken via the RCM module 132 given a set of failure modes or faults |
| | as established by the FMEA module 130. |

More regarding the above described service and maintenance modules 130-136 is presented in later paragraphs. Those skilled in the art will recognize that the above stated modules employable by the ERP software tool 122 are but a few types of modules useful for enabling a machine maintenance feedback system as presented. Also, skilled practitioners will recognize that integration and sharing of a common database resource amongst the various executable modules 130-136 is indeed a key functional intention of typical ERP systems 122. Other functional and/or management control modules 138 may also be employed by the ERP system 122, such as those for performing supply chain related functions, logistics, dashboard indicator generation, skill set evaluation, documentation generation and procurement and other controls that enable the service maintenance provider to meet customer needs. The ERP tool 122 may also employ one or more of the various management modules employed by the ADF management module 112 for the benefit of the service maintenance provider 100 as well as the customer of the document processing environment 102. In some implementations, it may be advantageous for the ERP tool 122 to be communicable with both the hosted and local operating ADF management modules 112 and 110, respectively.

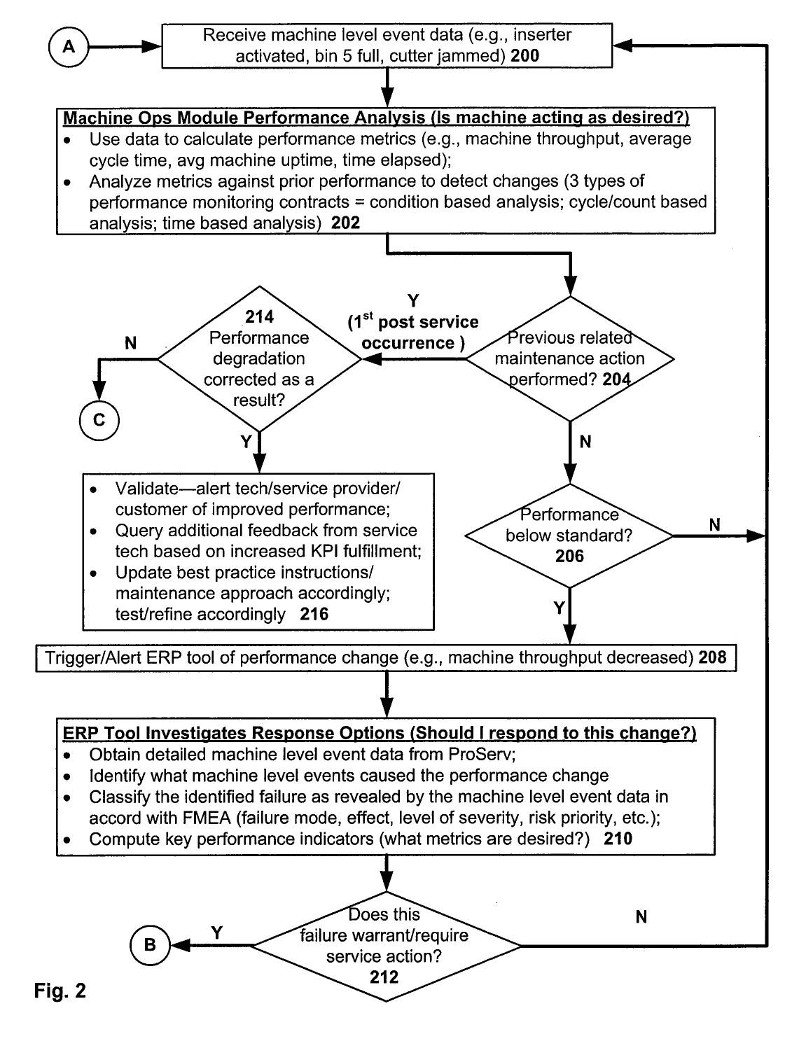

Ultimately, interaction of the above described components 104, 114, 116, 120, 122, 130-138, 150, 152 and optionally 110 and 112, comprise a machine maintenance feedback system that enables the service maintenance provider 100 to respond to service requests or requirements of a particular machine 106. The various bi-directional arrows shown between components illustrate the nature of the exchange process between them, though specific configurations may vary as required. For example, in some implementations, it may be advantageous for the ERP tool 122 to be communicable with both the hosted and local operating ADF management modules 112 and 110, respectively. In other instances, the ERP tool 122 may interact directly with the hosted and/or local machine operations modules 104 and 120—i.e., wherein no ADF management nodule 112/110 need be employed at all. The relationships and interactions between these components is further explored in the exemplary flowcharts of FIGS. 2-4, which depict the logical steps employed by the components of the machine maintenance feedback system for responding to degradation in machine operational performance.

In FIG. 2, machines 106 within the document processing environment 102 convey machine level event data to the machine operations module 120/104 (and optionally the ADF management modules 110/112) via the machine level event collector 116 (event 200). Upon receipt, the machine operations module 120/104 local ADF module calculates various metrics indicative of the operational performance of the machine 106 such as machine throughput, cycle time or machine uptime based on the machine level data. In an effort to determine if the operational performance has degraded, the determined metrics are compared against the machine's prior operational performance (event 202). Degradation of performance may be determined to within a predetermined threshold or variance as established by the maintenance service provider 100 or the customer of the mail processing environment 102.

For the sake of clarity, determining the machine operational performance based on current run-time data (performance checks), accessed in real-time or near real-time, is of particular advantage to the skilled practitioner. Such performance checks may be performed by the maintenance service provider in various ways. For example, the maintenance agreement between parties may call for the service provider 100 to perform conditional performance checks, wherein the check is triggered by the occurrence of a particular condition or metric calculation. Alternatively, the service provider 100 may perform cycle based or periodic performance checks, wherein the frequency or period is established in the maintenance agreement. Regardless of the chosen procedure, those skilled in the art will recognize the significance of persistent and/or periodic performance checks for determining the presence of satisfactory or even unsatisfactory machine behavior in real-time.

When performance is determined to be unsatisfactory—i.e., machine operational performance degradation has occurred—the machine operations module 120/104 alerts the ERP tool 122. The ERP tool 122 then queries the ADF management module 112/110 to obtain detailed machine level event data, and particularly that used as input for calculation of the performance metrics. Once identified, the ERP tool 122 calls upon the FMEA module 130 to conduct a failure modes and effects analysis using the data. Such analysis results in an identification of various situational factors, including a classification of the type of failure mode or fault that may be associated with the machine level event, its effect upon the machine, the level of severity of the failure mode or fault, its risk priority, etc. Analysis performed by the FMEA module 130 may include further query of the machine level event data collector 116 (and optionally the module level event data collector 114) for determining a specific component or group thereof from which the identified failure mode or fault may extend. For instance, if the machine level event data indicates that machine 106 is “not responsive or offline” the FMEA module 130 may use this data to isolate the cause of the problem as being the power distribution system of the machine. Further pinpointing of various failure modes and corresponding effects may yield:

Failure Mode A=Voltage and Current Harmonics; Effect=System heating, degradation of electronic components and controls; Severity=3; Occurrence=2; Risk Priority Limits=3% Current and 5% Voltage, etc.

Failure Mode B=Voltage Unbalance; Effect=Can cause winding failure in the primary transport motor; Severity=8; Occurrence=2; Risk Priority Limits=limits are 7% Voltage, etc.

Failure Mode C=Power Factor; Effect=Can cause winding overload, cable faults and can exaggerate other electrical faults including voltage sag on motor starting; Severity=2; Occurrence=4; Risk Priority Limits=limits are 8% Voltage, etc.

The FMEA module 130 may then engage further analysis based on known factors, such as the effect data, severity data, occurrence data, risk priority limit data as presented, in order to determine a pinpoint a particular failure mode. In some instances, the FMEA module 130 may pinpoint a limited set of potential failure modes depending on the nature of the identified machine level event data presented to it.

As a result of the FMEA module 130 analysis yielding specific failure modes associated with the received machine level event data, the KPI module 136 may then analyze this machine level event data against key performance indicators to ascertain the extent to which the data corresponds to desired performance objectives (event 210). For example, a key performance indicator for the maintenance service provider 100 may be reduced machine service time, increased workload capacity (revenue generated per technician) or increased system availability for the customer. KPIs computed from the perspective of the customer's exemplary mail processing machine environment 102 may be increased service call response time, reduced system failure or increased customer satisfaction. Indeed, the objectives of the service provider 100 and customer's document processing environment 102 may, and in many instances, should be in alignment. Hence, the KPI module 136 may compute various metrics associated with such critical success factors, be they from the common or individual perspective of the service provider 100 and document processing environment 102.

Ultimately, the KPI module 136 assesses whether the particular identified machine level event data that rendered the identified failure mode or fault requires service action or intervention of any kind (event 212). This is of particular importance, as the KPI module 136 helps prevent unnecessary service action from being requested given that not every identified fault or failure mode may warrant service action. The decision whether to pursue a service action is also based in part on the chosen maintenance approach dictated by the RCM module 132, which may define various approaches as predictive maintenance, conditional monitoring, run-to-failure or preventative maintenance model or approach. For example, if a particular failure mode is classified in association with a conditional monitoring approach, this failure mode must meet specified conditions in order to warrant employment of a service action. As another example, if a particular failure mode is classified in association with a run-to-failure approach, this failure mode must meet failure conditions in order to warrant employment of a service action. In the first example, application of a particular service action may occur more often as conditions are met, while in the latter less often as complete failure occurs.

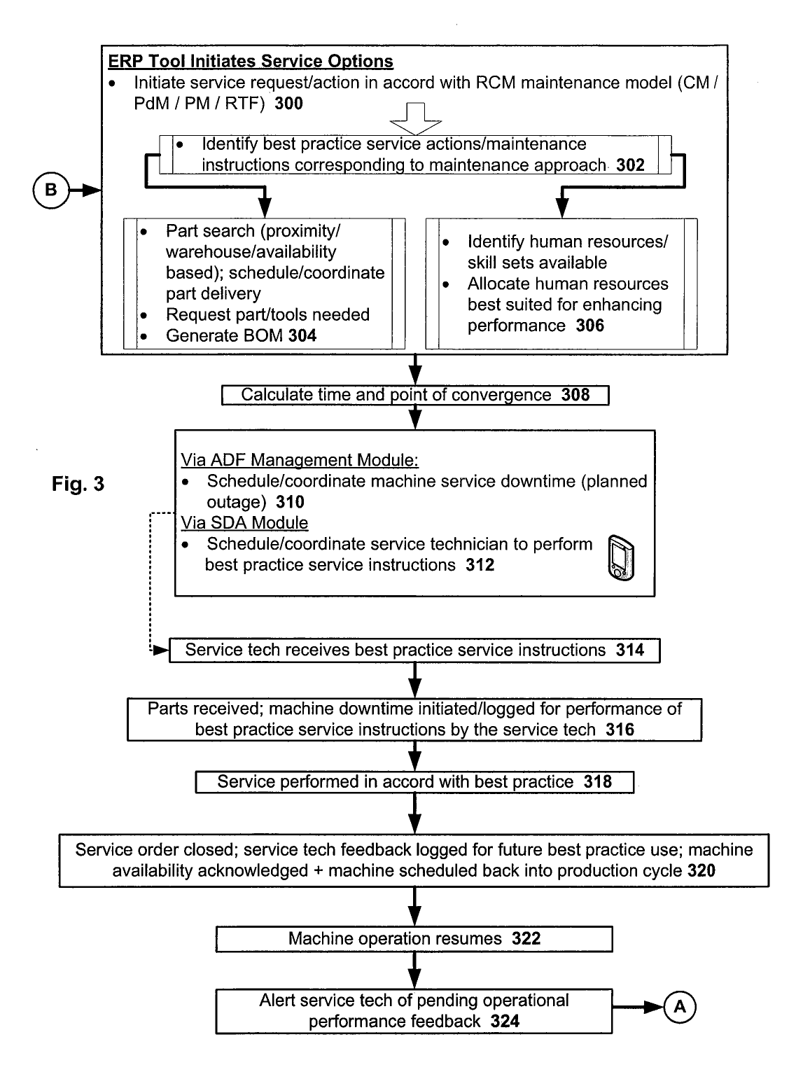

When it is determined that no service action is warranted, monitoring of machine level event data (event 200) commences. However, when a service action is warranted, the ERP tool 122 calls upon the RCM module to initiate the action in accord with the maintenance approach or model associated with the identified failure mode or fault (event 300), as depicted in FIG. 3. Specifically, the RCM module 132 of the ERP tool 122 identifies the best practice service instructions corresponding to the determined maintenance approach (event 302). In the context of the present teachings, the best practice service instructions represent a set of actions to be undertaken by the service provider 100 for addressing an identified failure mode or fault. Instructions may be pulled from a service database accessible to the ERP tool 122 in accord with known referencing or indexing techniques. Having selected the appropriate best practice instructions, the ERP tool 122 may then call upon the necessary modules to coordinate the resources needed to carry out the best practice service instructions. This may include, but is not limited to, conducting a part search based on proximity or warehouse availability or generating a bill of materials (BOM) via a work order generation and entry module (event 304). This may also include, but is not limited to, performing a service skills assessment and evaluation of the service personnel best suited and available for performing the required best practice service instructions via a business intelligence or personnel module (event 306). Ultimately, these and other resources may be coordinated to a point (e.g., location of the machine to be serviced) and time (e.g., date of delivery of the necessary part) of convergence (event 308).

In addition to or concurrent with events 302-308 described above, the ERP tool 122 may also schedule and coordinate service downtime for the machine (event 310) as well as schedule and coordinate a service technician to perform the best practice service instructions upon the machine (event 312). Coordination and scheduling of service downtime for the machine may be executed on an automated basis by the ERP tool 122 via the ADF management module 112/110 as a production or workflow management function within the document processing environment 102. Coordination and scheduling of the service technician 154 may be executed on an automated basis by the ERP tool 122 via business intelligence or personnel management modules in conjunction with the SDA module 134. The SDA module 134 may enable real-time communication of the service request to select service personnel via a Smartphone, Blackberry™ or other network communication device 152, along with communication of the recommended best practice service instructions to be performed (event 314), the point and time of convergence, parts delivery or pickup information, etc. Moreover, the select service personnel may also provide response or feedback information upon receipt of the instructions, such as to confirm availability, inform of known challenges, etc. This feedback may be utilized to recalculate a point and time of convergence if necessary and to re-coordinate the necessary resources in case the select personnel (e.g., a field service technician identified as best suited for the request) is not available or current field service conditions pose limitations.

Once the various above described resources converge at the scheduled point and time, the parts are received, and the machine downtime is initiated (event 316), the best practice service instructions may be executed accordingly (event 318). Once completed, the service technician 154 may validate completion of the service request/order and log any notes or feedback related to the service request via their network communication device 152 (event 320). The feedback provided by the service technician 154, which may include a variation in technique or approach from that prescribed by the best practice service instructions, may be utilized in the future for refining the best practice service instructions prescribed in relation to the identified failure mode. This of course depends on the extent to which the completed service request results in satisfactory machine operational performance, and to the extent to which the service technician's completed work better enables and aligns with the key performance indicators of the service provider 100 or the customer.

Once the completion notification is received by the ERP tool 122 from the service technician 154 via the SDA module 134, the ERP tool 122 may schedule the machine back into the production cycle in conjunction with the ADF module 112/110 (event 322); enabling it to begin its operation. In addition, the ERP tool 122 also sends notification to the service technician 154 of pending machine operational performance status information (event 324), feedback sufficient to enable the service technician to know the effect of their recently completed service action on actual machine performance. Depending on the workload requirements of the service technician 154 and/or the anticipated amount of time in which the machine may be placed online or back into production, the service technician 154 may or may not indicate their ability to STANDBY pending receipt of performance status information.

With reference again to FIG. 2, as before, machine operation results in the generation of module level and machine level event data (event 200) pertaining to the machine, which is used to generate performance metrics indicative of the current operational performance of the machine since it was serviced. When the performance metrics calculated are related to the service recently performed on an associated machine (event 204), the machine operations module 104/120 further determines if satisfactory machine operational performance (event 214) was rendered as a result. If satisfactory—i.e., marked improvement to within a particular threshold or variance—the machine operations module 120 validates the improvement. In this way, the performance enhancement is visible in real-time to both the maintenance service provider 104 (e.g., at a command center) as well as to the customer within the document processing environment 102. In addition, the ERP tool 122 may alert the service technician 154 of the enhanced performance. Validation information may include detailed before and after performance metric data, benchmark indicators, performance standard data and any other details.

Once all parties are notified of the increased machine operational performance achieved, the KPI module 136 may then analyze the associated machine level event data against key performance indicators to ascertain the extent to which the data corresponds to desired performance objectives (event 210). If key success factors are achieved, and particularly exceeded, the ERP tool 122 may query the service technician 154 for additional feedback regarding their service activities and actions, and this information may be used to automatically update the best practice service instructions data (event 216). Those skilled in the art will recognize that the automated refining of the best practice service instructions may be performed in various ways, including via known data cleansing, data conversion, document and database change control and automated database or document conversion techniques. Further test and manual refinement may also be performed if necessary.

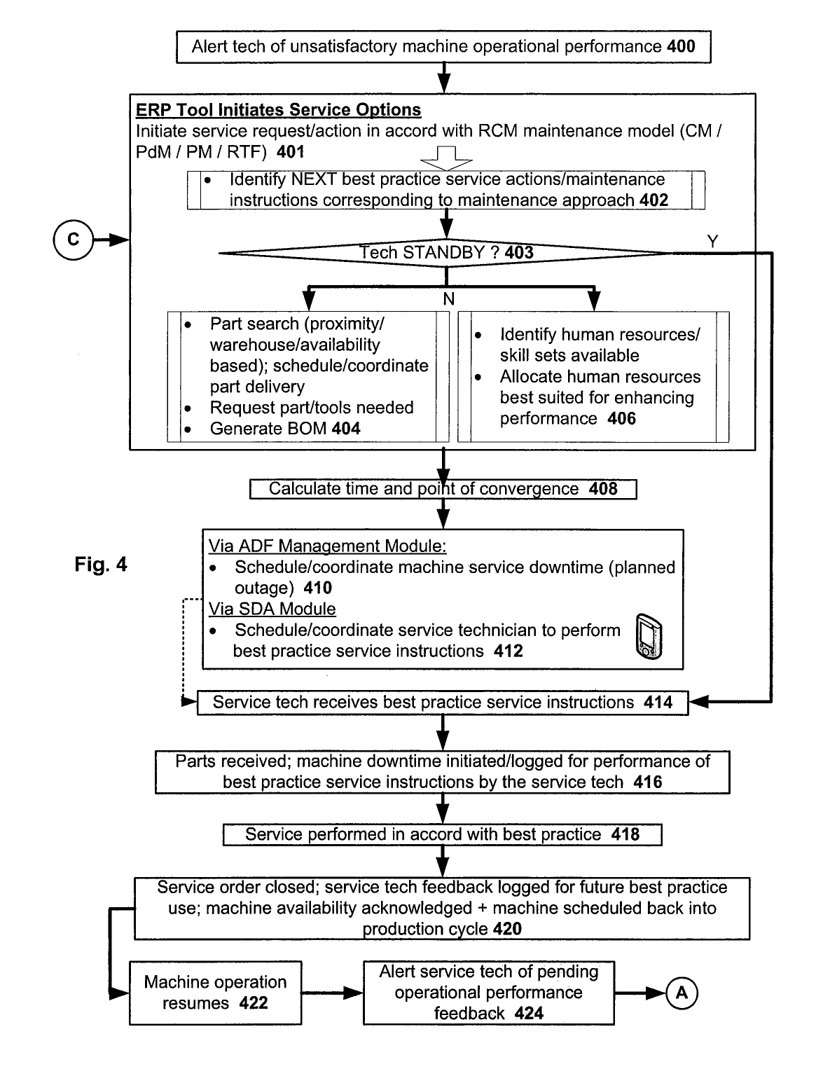

When the machine operational performance has not improved in relation to recently performed best practice service instructions—i.e., the same performance degradation persists for the machine in question—the response is as depicted in FIG. 4. In particular, once the service technician has been alerted of the unsatisfactory performance (event 400), the ERP tool 122 calls upon the RCM module 132 to identify and initiate the next best practice service instructions corresponding to the already determined maintenance approach (event 401). Next best practice service instructions represent a subsequent set of actions to be undertaken rather than the primary instructions presented before. If the service technician 154 indicated that they were available to STANDBY, i.e. stay within proximity of the machine in question to perform immediate follow-up service, assuming no additional parts need be convened, the ERP tool 122 may simply communicate the identified next best practice instructions (events 402 and 414). However, if the service technician did not indicate availability to STANDBY, i.e. could not stay within proximity of the machine in question to perform immediate follow-up service, the ERP tool 122 may then call upon the necessary modules to coordinate the resources needed to carry out the next best practice service instructions. As before, this may include conducting a part search, generating a bill of materials (BOM), performing a service skills assessment and evaluation, and other resource coordination to a point and time of convergence (events 404-408).

In addition to or concurrent with events 404-408, the ERP tool 122 may also schedule and coordinate service downtime for the machine (event 410) as well as schedule and coordinate a service technician to perform the best practice service instructions upon the machine (event 412). Coordination and scheduling of service downtime for the machine may be executed on an automated basis by the ERP tool 122 via the ADF management module 112/110 as a production or workflow management function within the document processing environment 102. Coordination and scheduling of the service technician 154 may be executed on an automated basis by the ERP tool 122 via business intelligence or personnel management modules in conjunction with the SDA module 134. The SDA module 134 may enable real-time communication of the service request to select service personnel via a Smartphone, Blackberry™ or other network communication device 152, along with communication of the recommended best practice service instructions to be performed (event 314), the point and time of convergence, parts delivery or pickup information, etc. Moreover, the select service personnel may also provide response or feedback information upon receipt of the instructions, such as to confirm availability, inform of known challenges, etc. This feedback may be utilized to recalculate a point and time of convergence if necessary and to re-coordinate the necessary resources in case the select personnel (e.g., a field service technician identified as best suited for the request) is not available or current field service conditions pose limitations.

Once the various above described resources converge at the scheduled point and time, the parts are received, and the machine downtime is initiated (event 416), the next best practice service instructions may be executed accordingly (event 418). As before, the service technician 154 may validate completion of the service request/order and log any notes or feedback related to the service request via their network communication device 152 (event 320). Once the completion notification is received by the ERP tool 122 from the service technician 154 via the SDA module 134, the ERP tool 122 may schedule the machine back into the production cycle in conjunction with the ADF module 112/110 (event 322); enabling it to begin its operation. In addition, the ERP tool 122 also sends notification to the service technician 154 of pending machine operational performance status information (event 324), feedback sufficient to enable the service technician to know the effect of their recently completed service action on actual machine performance.

From here on, the steps of FIG. 2 and FIG. 4 are repeated as necessary to resolve the performance degradation originally determined in association with the machine in question. Of course, those skilled in the art will recognize that such repetition of response with the intent of achieving desired performance results, enables a means of closed loop corrective feedback. Furthermore, those skilled the art will recognize that the above described teachings enable a means of proactive automation of critical activities necessary for addressing machine operational performance issues, including: automated prompting and communication of machine operational performance status in response to a performed service request, automated prompting of service technician feedback in response to the detection of performance exceeding expectations, automated adaptation of best practices information in response to the detection of performance exceeding expectations, and automated selection of next best practices service instructions in response to the detection of unsatisfactory machine operational performance status subsequent to execution of a service request.

As shown by the above discussion, aspects of the document processing environment and modules are controlled or implemented by one or more processors/controllers, such as one or more computers or servers. Typically, each such processor/controller is implemented by one or more programmable data processing devices. The hardware elements operating systems and programming languages of such devices are conventional in nature, and it is presumed that those skilled in the art are adequately familiar therewith.

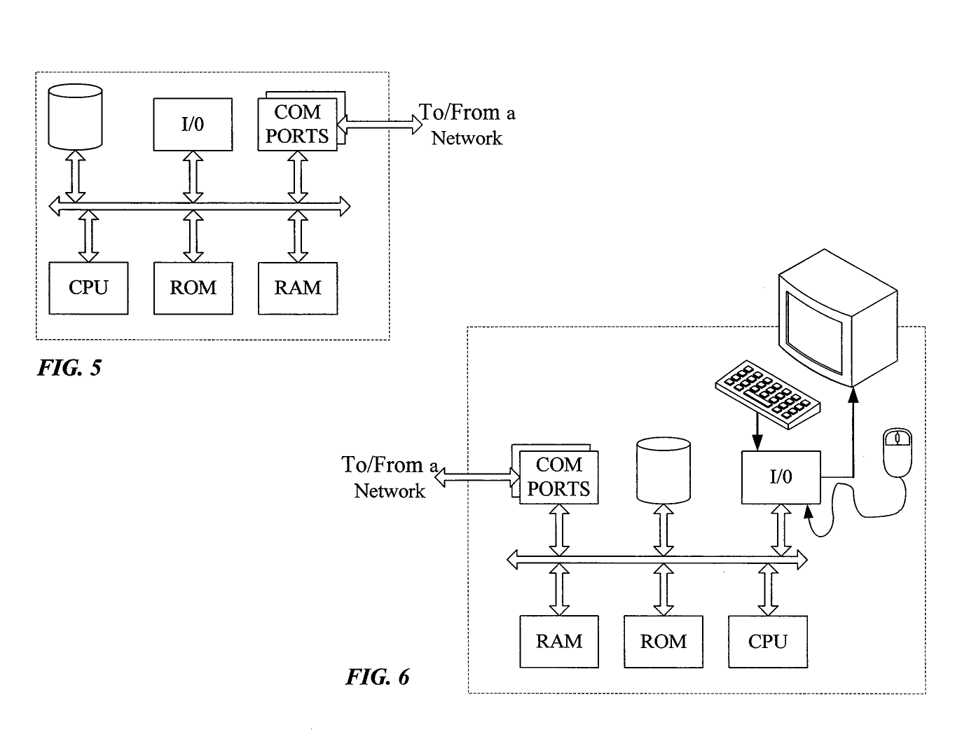

FIGS. 5 and 6 provide functional block diagram illustrations of general purpose computer hardware platforms. FIG. 5 illustrates a network or host computer platform, as may typically be used to implement a server. FIG. 6 depicts a computer with user interface elements, as may be used to implement a personal computer or other type of work station or terminal device, although the computer of FIG. 6 may also act as a server if appropriately programmed. It is believed that those skilled in the art are familiar with the structure, programming and general operation of such computer equipment and as a result the drawings should be self-explanatory.

For example, the processor/controller may be a PC based implementation of a central control processing system, or may be implemented on a platform configured as a central or host computer or server. Such a system typically contains a central processing unit (CPU), memories and an interconnect bus. The CPU may contain a single microprocessor (e.g. a Pentium microprocessor), or it may contain a plurality of microprocessors for configuring the CPU as a multi-processor system. The memories include a main memory, such as a dynamic random access memory (DRAM) and cache, as well as a read only memory, such as a PROM, an EPROM, a FLASH-EPROM, or the like. The system memories also include one or more mass storage devices such as various disk drives, tape drives, etc.

In operation, the main memory stores at least portions of instructions for execution by the CPU and data for processing in accord with the executed instructions, for example, as uploaded from mass storage. The mass storage may include one or more magnetic disk or tape drives or optical disk drives, for storing data and instructions for use by CPU. For example, at least one mass storage system in the form of a disk drive or tape drive, stores the operating system and various application software as well as data, such as sort scheme instructions and tracking or postage data generated in response to the sorting operations, as discussed in detail above. The mass storage within the computer system may also include one or more drives for various portable media, such as a floppy disk, a compact disc read only memory (CD-ROM), or an integrated circuit non-volatile memory adapter (i.e. PC-MCIA adapter) to input and output data and code to and from the computer system.

The system also includes one or more input/output interfaces for communications, shown by way of example as an interface for data communications with one or more other processing systems and in the case of the sorter computers for communication with the reader and sorting hardware elements. Although not shown, one or more such interfaces may enable communications via a network, e.g., to enable sending and receiving instructions electronically. The physical communication links may be optical, wired, or wireless.

The computer system may further include appropriate input/output ports for interconnection with a display and a keyboard serving as the respective user interface for the processor/controller. For example, a sorter computer may include a graphics subsystem to drive the output display. The output display, for example, may include a cathode ray tube (CRT) display, or a liquid crystal display (LCD) or other type of display device. Although not shown, a PC type system implementation typically would include a port for connection to a printer. The input control devices for such an implementation of the system would include the keyboard for inputting alphanumeric and other key information. The input control devices for the system may further include a cursor control device (not shown), such as a mouse, a touchpad, a trackball, stylus, or cursor direction keys. The links of the peripherals to the system may be wired connections or use wireless communications.

The computer system runs a variety of applications programs and stores data, enabling one or more interactions via the user interface provided, and/or over a network (to implement the desired processing, in this case, including those for processing mail item data as discussed above.

The components contained in the computer system are those typically found in general purpose computer systems. Although summarized in the discussion above mainly as a PC type implementation, those skilled in the art will recognize that the class of applicable computer systems also encompasses systems used as host computers, servers, workstations, network terminals, and the like. In fact, these components are intended to represent a broad category of such computer components that are well known in the art.

Hence aspects of the techniques discussed herein encompass hardware and programmed equipment for controlling the relevant mail processing as well as software programming, for controlling the relevant functions. A software or program product, which may be referred to as an “article of manufacture” may take the form of code or executable instructions for causing a computer or other programmable equipment to perform the relevant data processing steps regarding mail item tracking or processing, where the code or instructions are carried by or otherwise embodied in a medium readable by a computer or other machine. Instructions or code for implementing such operations may be in the form of computer instruction in any form (e.g., source code, object code, interpreted code, etc.) stored in or carried by any readable medium.

Such a program article or product therefore takes the form of executable code and/or associated data that is carried on or embodied in a type of machine readable medium. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another, for example, from a management server or host computer. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the sorting control and attendant mail item tracking based on unique mail item identifier. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

In the previous description, numerous specific details are set forth, such as specific materials, structures, processes, etc., in order to provide a better understanding of the present subject matter. However, the present subject matter can be practiced without resorting to the details specifically set forth herein. In other instances, well-known processing techniques and structures have not been described in order not to unnecessarily obscure the present subject matter.

Only the preferred embodiments of the present subject matter and but a few examples of its versatility are shown and described in the present disclosure. It is to be understood that the present subject matter is capable of use in various other combinations and environments and is susceptible of changes and/or modifications within the scope of the inventive concept as expressed herein. It is intended by the following claims to claim any and all applications, modifications and variations that fall within the true scope of the present teachings.

What is claimed:

1. A method for closed loop monitoring and control of performance of document processing equipment within a document processing facility, the method comprising steps of:
gathering a plurality of performance metrics that characterize the operational performance of document processing equipment within the document processing facility;
detecting a performance degradation of the document processing equipment based on the generated performance metrics;
upon detection of the performance degradation, triggering a corrective response action comprising steps of:
identifying event data for isolating one or more specific functional or physical causes of the degradation associated with the document processing equipment;
coordinating resources necessary for executing identified best practice service instructions; and
upon execution of the best practice service instructions, validating that operational performance of the document processing equipment is corrected.

2. The method of claim 1, wherein the gathering step occurs during operating time of the document processing equipment.

3. The method of claim 1, wherein the identifying step includes:
identifying the event data of the document processing equipment that led to the type of performance degradation detected.

4. The method of claim 3, wherein the event data is an aggregate of raw data gathered during run time or fault time of the document processing equipment.

5. The method of claim 1, further comprising a step of:
identifying best practice service instructions to be performed for addressing the functional or physical causes of the degradation associated with the document processing equipment.

6. The method of claim 1, wherein the validating step includes:
comparing performance metrics as determined before execution of the best practice service instructions with performance metrics determined upon execution of the best practice service instructions.

7. The method of claim 1, wherein the document processing equipment is selected from sorters, inserters, cutters, printers, folders or mail bins.

8. A computer programmed to implement the steps of the method of claim 1.

9. An article of manufacture, comprising:
a machine readable storage medium; and
an executable program embodied in the storage medium for causing a computer to implement the steps of the method of claim 1.

10. A method for coordinating resources in response to performance degradation of document processing equipment within a document processing facility, the method comprising steps of:
identifying one or more best practice service instructions from a set to be performed to address the performance degradation, the performance degradation including one or more specific functional or physical causes of the degradation associated with the document processing equipment;
coordinating resources for executing the one or more best practice service instructions, the resources selected from one or more of the following: a part, production scheduling, skill set, personnel or equipment;
validating that operational performance of the document processing equipment is corrected following execution of the one or more best practice service instructions; and
upon validation, updating the set of best practice service instructions.

11. The method of claim 10, wherein the validating step includes:
comparing performance metrics as determined before execution of the best practice service instructions with performance metrics determined upon execution of the best practice service instructions.

12. The method of claim 10, wherein the document processing equipment is selected from sorters, inserters, cutters, printers, folders or mail bins.

13. A computer programmed to implement the steps of the method of claim 10.

14. An article of manufacture, comprising:
a machine readable storage medium; and
an executable program embodied in the storage medium for causing a computer to implement the steps of the method of claim 10.

15. A method for arranging a service request in response to performance degradation of document processing equipment within a document processing facility, the method comprising steps of:
receiving notification of implementation of one or more best practice service instructions on the document processing equipment, the best practice instructions implemented in response to detected degradation in the document processing equipment;
activating the document processing equipment subsequent to the implementation of the one or more best practice service instructions;
requesting a service request to standby pending a determination of operational performance of the document processing equipment subsequent to the implementation of the one or more best practice service instructions;
evaluating the operational performance of the document processing equipment subsequent to the activation of the document processing equipment; and
alerting the service technician to implement an additional best practice service instructions when the degradation still persists based upon results of the evaluation.

16. The method of claim 15, wherein the document processing equipment is selected from sorters, inserters, cutters, printers, folders or mail bins.

17. The method of claim 15, wherein the alerting step includes:
sending the service technician instructions to a portable network communication device.

18. The method of claim 15, wherein the evaluating step includes:
comparing performance metrics as determined before the best practice service instructions are implemented with performance metrics as determined after implementation of the best practice service instructions.

19. A computer programmed to implement the steps of the method of claim 15.

20. An article of manufacture, comprising:
a machine readable storage medium; and
an executable program embodied in the storage medium for causing a computer to implement the steps of the method of claim 15.
